(19) United States
(12) Patent Application Publication
(10) Pub. No.: US 2025/0187068 A1
(43) Pub. Date: Jun. 12, 2025

(54) COOLING VALVE PISTON IN CASTING DIE

(71) Applicant: Bholster Technologies, Toronto (CA)

(72) Inventor: Rabindra BHOLA, Toronto (CA)

(21) Appl. No.: 18/923,271

(22) Filed: Oct. 22, 2024

Related U.S. Application Data
(60) Provisional application No. 63/606,979, filed on Dec. 6, 2023.
(60) Provisional application No. 63/697,734, filed on Sep. 23, 2024.

(51) Int. Cl. B22D 17/22; B22D 17/14; F16K 3/26; F16K 49/00

(52) U.S. Cl. CPC B22D 17/2218; B22D 17/145; F16K 3/26; F16K 49/005

(57) ABSTRACT

A cooling apparatus for a valve piston of a casting die includes a base mountable to the casting die, an opening in a back end of the valve piston extending towards a front end of the piston facing the molten metal, and a hollow shaft extending from the opening for slidably engaging the base. To provide the coolant to the inside of the piston, a coolant delivery tube may extend from the base into the opening in the back end through the hollow shaft. Thus, the cooling apparatus does not require any plumbing appendages to the piston that might impede its movement in the casting die during normal operation.

### REFERENCE TO RELATED APPLICATION

This application claims priority from a U.S. Provisional application No. 63/606,979 filed on Dec. 6, 2023, entitled “Internal Cooling Apparatus for Movable Pistons in High-Pressure Die Casting Valves”, and a U.S. Provisional application No. 63/697,734 filed on Sep. 23, 2024, entitled “Pressure-Resistant Valve for Casting Die”. Both applications are incorporated herein by reference in their entireties.

### TECHNICAL FIELD

The present disclosure relates to die casting, and in particular to venting systems for die casting.

### BACKGROUND

In a die casting process, molten metal is rapidly injected at high pressure into a cavity formed between mold halves, and the metal is then allowed to cool down and solidify to form a mechanical component or part having the shape of the cavity. Due to the quick casting time and the ability to rapidly produce a large number of parts, die casting can significantly reduce manufacturing costs.

Resident air in the casting cavity may be cornered and compressed by the injection molten metal to form porosity in the part being manufactured. Accordingly, it is desired to evacuate as much air as possible, so that the remaining trapped air is compressed to small volume resulting in tolerable levels of porosity.

Some die casting apparatuses use vent valves that allow the air to escape as the molten metal enters the cavity of the casting die. The vent valves need to be operated with precise timing, allowing as much air to escape as possible while closing on time to prevent the molten metal from escaping the die, which may present a safety hazard and/or fill the vent valve mechanism and solidify, making it unusable for future molding cycles.

A vent valve of a die casting apparatus may be provided with a movable piston that remains open while the air escapes the mold and closes just in time to prevent the molten metal from escaping the casting cavity. Due to direct contact with molten metal e.g. molten aluminum, the piston tends to heat up during production. An overheated piston expands, which may cause stiction of the piston in the cylinder. In the prior art, such movable pistons may have been cooled down by externally spraying them during a die-open stage of a production casting cycle, which slows down the casting process, and may have side effects such as buildup of solid deposits on the valve.

### BRIEF DESCRIPTION OF THE DRAWINGS

Exemplary embodiments will now be described in conjunction with the drawings, in which:

FIG. 1 is a view of two open halves of a prior-art casting die;

FIG. 2 is a cross-sectional view of a prior-art hydraulic arm;

FIG. 3 is an exploded cross-sectional view of a cooled die casting valve of this disclosure;

FIG. 4A is a cross-sectional view of the die casting valve of FIG. 3 in an open position;

FIG. 4B is a cross-sectional view of the die casting valve of FIG. 3 in a closed position;

FIG. 5A is a 3D cross-sectional view of an embodiment of the die casting valve of FIG. 3 in the open position;

FIG. 5B is a 3D cross-sectional view of an embodiment of the die casting valve of FIG. 3 in the closed position;

FIG. 6A is a cross-sectional view of a cone-shaped die casting valve in an open position;

FIG. 6B is a cross-sectional view of the cone-shaped die casting valve in a closed position; and

FIG. 7 is a flow chart of a method of this disclosure for cooling a valve piston of a casting die.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

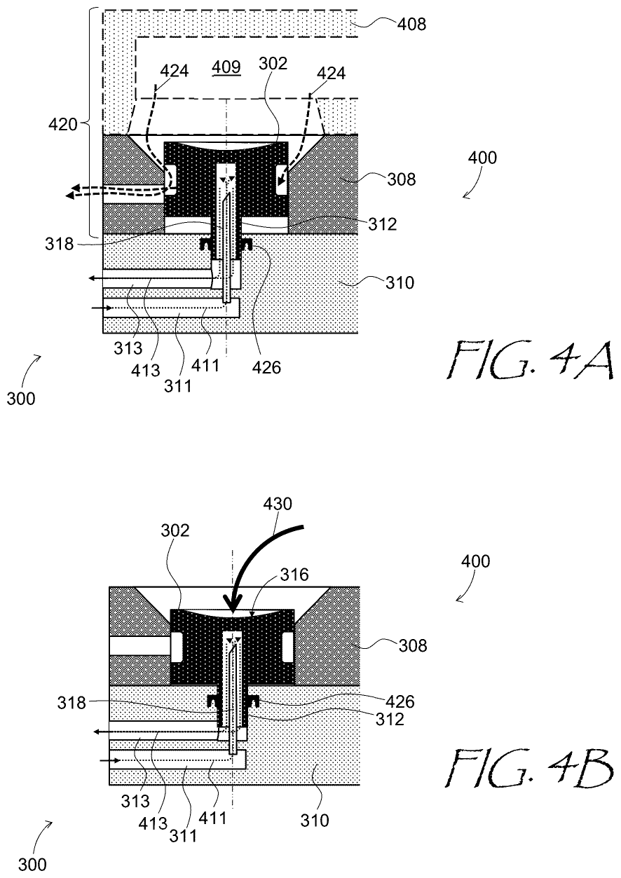

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated. In FIGS. 3 and 4A-4B to 6A-6B, similar reference numerals refer to similar elements.

A slidable air-vent piston is subject to heating by molten metal injected into a casting die at high pressure and contacting the piston. As the piston holds the pressure of the molten metal while it cools down and solidifies, the temperature of the piston may rise quicker than the temperature of the surrounding die, due to the piston being a separate part of the casting die. This may cause the piston to over-expand and get stuck in the die until the piston cools down enough to move freely again.

Previously, movable pistons may have been cooled by externally spraying them during a die-open stage of the casting cycle. Such cooling method, however, is not free from drawbacks. External spraying may take too long, slowing down production and consequently increasing cost per part. Spraying procedures need to be carefully followed to ensure proper functioning of the valve. The spraying material may include dissolved solids, which may form build-up on the valve, which impedes its proper functioning.

In accordance with this disclosure, the valve piston may be cooled not externally but internally, obviating the need for external spraying, thus providing a more time-efficient and reliable method of keeping the piston temperature under control. The cooling apparatus of the present disclosure does not require any plumbing attachment to cool the piston. The internal cooling may be achieved while the back of the piston is solidly supported to withstand high pressure of the molten metal. Before the present disclosure, it was believed that an internal cooling apparatus and/or plumbing would be too bulky to fit within a small die casting valve.

In accordance with the present disclosure, there is provided a cooling apparatus for a valve piston comprising opposed front and back ends. The front end is configured to face a molten metal injected into a casting die. The cooling apparatus comprises a base mountable to the casting die, an opening in the back end of the valve piston extending towards its front end, and a hollow shaft extending from the opening for slidably engaging the base. The opening may be substantially parallel to/coaxial with a movement direction of the valve piston or coaxial with the valve piston. The coolant delivery apparatus may be absent any plumbing passages affixed to the valve piston.

The valve piston may be configured to slidably engage an opening in the casting die, and a coolant delivery tube may extend from the base into the opening in the back end through the hollow shaft. The coolant delivery tube may be disposed to never be in mechanical contact with the valve piston at any position of the latter during normal operation. An inlet/outlet pair may be provided in the base, one in fluid communication with the hollow shaft, and the other in fluid communication with the coolant delivery tube. The cooling apparatus may include a slidable seal for sealing the hollow shaft in the base, to keep the coolant from leaking out.

In accordance with the present disclosure, there is provided a valve for a casting die. The valve comprises a base for mounting to the casting die, and a valve piston for sliding within a bottom plate of the casting die (which may be a part of the valve subassembly) between open and closed positions. The valve piston may include opposed front and back ends, the front end for facing the molten metal injected into the casting die; an opening in the back end extending towards the front end; and a hollow shaft extending from the opening away from the front end for slidably engaging the base. The opening may be substantially parallel to a movement direction of the valve piston, and/or coaxial with the valve piston. A slidable seal may be provided for sealing the hollow shaft in the base.

A coolant delivery apparatus may be provided for delivery of coolant into the opening. In some embodiments, a coolant delivery tube may extend from the base into the opening through the hollow shaft. The coolant delivery tube may, but does not have to, be substantially parallel to and/or coaxial with the opening and/or the hollow shaft. In some embodiments, coolant delivery tube is not in a mechanical contact with the valve piston at any position of the latter in the casting die, during normal operation. An inlet/outlet pair may be provided in the base, one in fluid communication with the hollow shaft, and the other in fluid communication with the coolant delivery tube, for delivery of the coolant. The valve piston may include a conical surface resting on a matched conical surface of the casting die when the valve piston is in the closed position. In some embodiments, a cross-sectional area of the opening is no greater than 10% of a cross-sectional area of the valve piston, and/or a distance between the open and closed positions of the valve piston is 4+/−1 mm.

In accordance with the present disclosure, there is further provided a method for cooling a valve piston comprising opposed front and back ends, the front end facing the molten metal injected into a casting die. The method comprises injecting a coolant into an opening in the back end of the valve piston through a hollow shaft extending from the opening away from the front end and slidably engaging a base mounted to the casting die. The method may further include controlling at least one of a duration of the injecting or a volume of the injected coolant in relation to a single casting cycle, for providing a pre-defined temperature range of the valve piston. The injecting may be performed using a coolant delivery tube extending from the base into the opening in the valve piston through the hollow shaft, such that the coolant delivery tube is not in a mechanical contact with the valve piston at any position of the latter in the casting die.

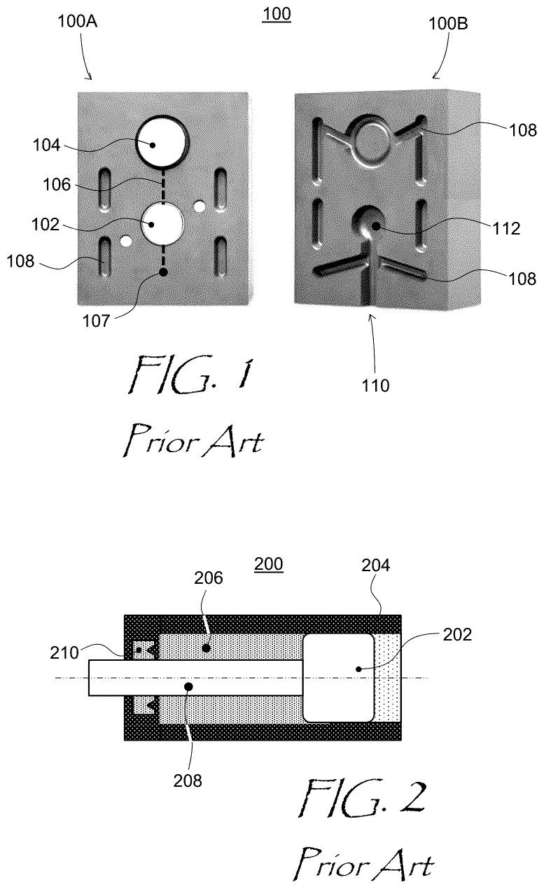

Referring now to FIG. 1, a prior-art vent valve 100 includes bottom 100A and top 100B portions. In FIG. 1, the bottom 100A and top 100B portions are unfolded, like an open book; the vent valve 100 is formed by joining the bottom 100A and top 100B portions together. The bottom portion 100A includes a melt piston 102 coupled to an evacuation piston 104 by a hidden lever arm 106. The lever arm 106 has a pivot 107 at the bottom, such that when the melt piston 102 moves up, the evacuation piston 104 moves up by a larger amount than the melt piston 102, and when the melt piston 102 moves down, the evacuation piston 104 moves down, also by a larger amount than the melt piston 102. Channels 108 are provided in the bottom 100A and top 100B portions for the molten metal to flow. The molten metal enters the vent valve 100 at a point 110 and propagates in the channels 108.

The molten metal accumulates in a melt piston cavity 112, eventually pressing onto the melt piston 102 and causing the melt piston 102 to go into the bottom portion 100A. The lever 106 converts the downward movement of the melt piston 102 into a downward movement of the evacuation piston 104 at a larger amplitude, blocking the path of molten metal evacuation through an air vent disposed under the evacuation piston 104.

One drawback of the prior-art vent valve 100 is that the melt piston 102 tends to overheat as compared to the rest of the vent valve 100 due to the heat escaping the melt piston 102 more slowly, i.e. slower than the rest of the vent valve 100. The overheating of the melt piston 102 may cause stiction of the entire mechanism. The valve apparatus of this disclosure, which will be considered in detail further below, aims to avoid overheating of the valve parts with the purpose of preventing stiction.

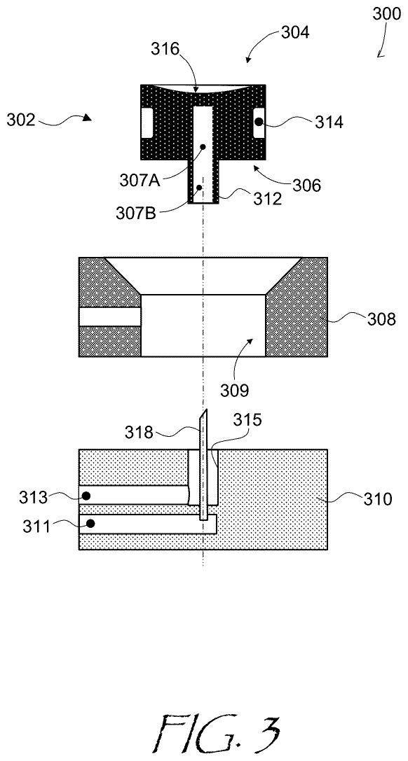

Referring to FIG. 2, a prior-art hydraulic arm 200 includes a piston 202 movable in a cylindrical hydraulic container 204 by pumping a fluid into a working area 206. The piston 202 moves under the pressure of the fluid and moves a rod 208 fed through the cylindrical hydraulic container 204 for transferring the movement force to outside environment for performing useful work. To prevent the fluid from leaking from the working area 206, one or more U-cup seals 210 may be provided. U-cup seals are known for their ability to self-tighten at high pressure.

FIG. 3 shows a cooling apparatus 300 of this disclosure. The purpose of the cooling apparatus 300 is to cool a valve piston 302. The cooling apparatus 300 is illustrated in an exploded cross-sectional view. The valve piston 302 includes opposed front 304 and back 306 ends. The valve piston 302 may be configured to slidably engage an opening 309 in a bottom plate 308 of a casting die. The front end 304 of the valve piston 302 is configured to face molten metal injected into the casting die during the casting process. The cooling apparatus 300 includes a base 310 mountable to the bottom plate 308.

An opening 307A may be provided in the back end 306 of the valve piston 302. The opening 307A in the valve piston 302 extends from the back end 306 towards the front end 304 of the valve piston 302. A hollow shaft 312 extends from the opening 307 towards the base 310, for slidably engaging the latter e.g. via a cylindrical opening 315. The opening 307A in the valve piston 302 and an opening 307B in the shaft 312 may, but do not have to, comprise a single continuous cylindrical opening, as illustrated. The piston 302 may include a perimeter cutout 314 in the cylindrical side of the valve piston 302, and/or a concave top surface 316. The purpose of the perimeter cutout 314 and the concave top surface 316 will be explained further below. The openings 307A, 307B may, but do not have to, be coaxial with the piston 302.

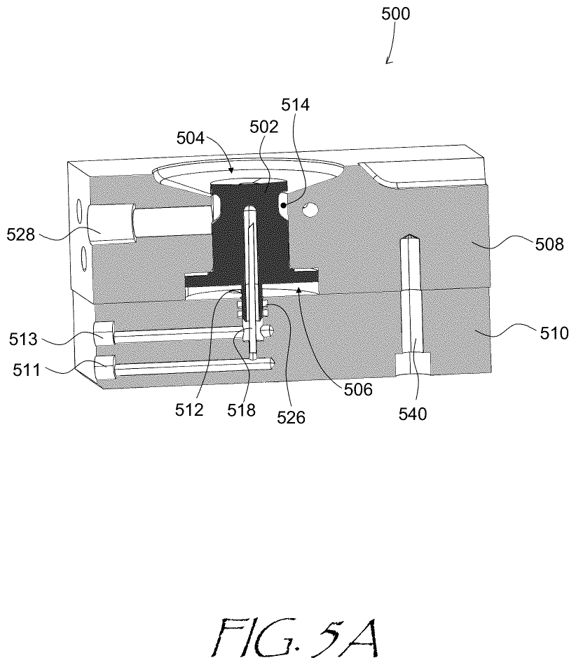

The cooling apparatus 300 may further include a coolant delivery apparatus for delivery of coolant into the opening 307A through the opening 307B in the hollow shaft 312, for cooling the piston 302. In the embodiment shown, the coolant apparatus 300 includes a coolant delivery tube 318 extending from the base 310 into the opening 307A in the back end 306 of the valve piston 302 through the opening 307B in the hollow shaft 312. The base 310 may include an inlet opening 311 and an outlet opening 313. The inlet opening 311 is in fluid communication with the coolant delivery tube 318, and the outlet opening 313 is in fluid communication with the with the opening 307B in the hollow shaft 312 when the cooling apparatus 300 is assembled for operation. The operation of the cooling apparatus is illustrated in FIGS. 4A and 4B.

Referring first to FIG. 4A with further reference to FIG. 3, the cooling apparatus 300 is integrated into a valve 400 for a casting die 420 including a top plate 408 and the bottom plate 308 defining a casting cavity 409 between them. The valve 400 includes the cooling apparatus 300 of FIG. 3, which cools the valve 400 in operation. The valve 400 includes the base 310 mounted to the bottom plate 308 of the casting die 420. The valve piston 302 slides within the bottom plate 308 between open and closed positions. In FIG. 4A, the valve 400 is shown in an open position that allows evacuation of gases (e.g. air) 424 from the casting cavity 409 of the casting die 420 ahead of the stream of molten metal filling in the casting cavity 409 during the casting process. In the embodiment shown, the gases 424 may evacuate through the perimeter cutout 314 in the valve piston 302, as illustrated.

The valve piston 302 includes the opposed front 304 and back 306 ends as explained above with reference to FIG. 3. The front end 304 is configured to face the molten metal injected into the casting cavity 409 (FIG. 4A) of the casting die 420. The opening 307A (FIG. 3) in the back end 306 extends towards the front end 304, i.e. extends into the valve piston 302. The hollow shaft 312 extends from the opening 307A in the back end 306 in an opposite direction, i.e. away from the front end 304 of the valve piston 302 for slidably engaging the opening 315 in the base 310. The opening 315 may, but does not have to, be coaxial with the valve piston 302. The opening 315 may, but does not have to, be substantially parallel a sliding direction of the valve piston 302. For certainty, the term “substantially parallel” or “substantially coaxial” is taken to mean parallel or coaxial to within 0.5 degrees.

The valve 400 (FIG. 4A)/the cooling apparatus 300 may further include a coolant delivery apparatus for delivery of coolant into the opening 307A in the valve piston 302, in a contactless manner not requiring any plumbing affixed to the valve piston 302. To that end, the valve 400 may include the coolant delivery tube 318 extending from the base 310 into the opening 307A through the hollow shaft 312. The inlet opening 311 is in fluid communication with the coolant delivery tube 318, and the outlet opening 313 is in fluid communication with the with the hollow shaft 312. The coolant may flow along an inflow path 411 into the coolant delivery tube 318, which directs the coolant to sprinkle and cool the valve piston 302 from inside. The coolant then may outflow along an outflow path 413. Notably, the coolant delivery tube 318 is not in a mechanical contact with the valve piston 302, which means that the operation of the valve piston 302 is not impacted by the cooling apparatus 300. To prevent the coolant from leaking and/or contacting the valve 400, a slidable seal, e.g. a U-cup seal 426, may be provided. The U-cup seal 426 slidably seals the hollow shaft 312 in the base 310 to restrain pressurized coolant (e.g. water) in the outflow path 413 from making a direct contact with the bottom plate 308. Other types of slidable seals such as O-ring, or a set of O-rings, may be used in place of, or together with, U-cup 426.

Referring now to FIG. 4B, the valve 400 is shown in a closed position that blocks the outflow of molten metal. The valve 400 may be closed shut by directing a stream 430 of molten metal onto the concave top surface 316 of the valve piston 302. The molten metal may be directed by a curved feature or channel in the casting die 420 to push the valve piston 302 by sheer kinetic momentum of the molten metal stream 430. The concave top surface 316 of the valve piston 302 facilitates redirection of the stream 430 of molten metal sideways and upwards, providing enough time for the valve 400 to close before the molten metal reaches the sides of the valve piston 302.

The cooling apparatus 300 may be activated during the closing and/or before the closing, as required to keep the valve piston 302 temperature within specified limits. It is to be noted that a length of the coolant delivery tube 318 may be selected so that the coolant delivery tube 318 is not in a mechanical contact with the valve piston 302 when the valve piston 400 is in closed position. In other words, the coolant delivery tube 318 is not in a mechanical contact with the valve piston 302 at any position of the valve piston 302 in the casting die 420 during the casting cycle, the coolant delivery tube 318 directing the coolant flow to the axially movable valve piston 302. There is no need to affix any plumbing passages to the valve piston 302; accordingly, the action of the valve 400 is not impeded by the cooling apparatus 300. The cooling apparatus 300 prevents the valve piston 302 from overheating and ensures stable performance of the die casting apparatus from cycle to cycle.

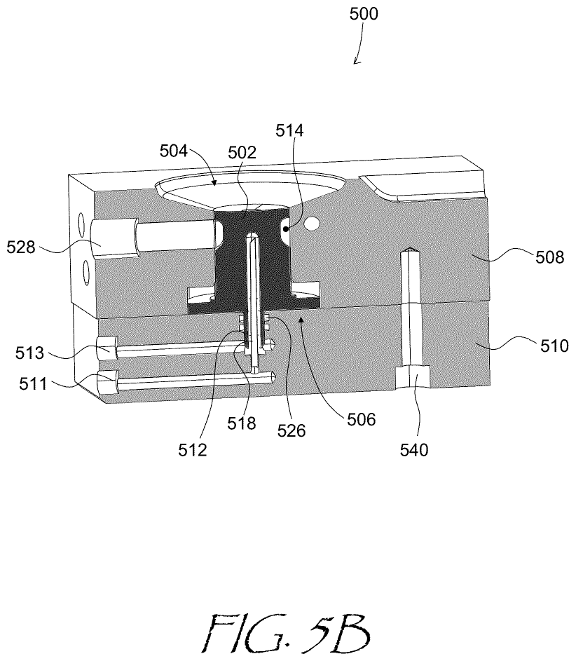

Referring now to FIGS. 5A and 5B, a die casting valve 500 is a non-limiting illustrative example implementation of the valve 400 of FIGS. 4A and 4B. The valve 500 includes a base 510 that may be mounted to a bottom plate 508 using a screw, not shown, inserted into a threaded hole 540. A valve piston 502 is configured for sliding within the bottom plate 508 between open and closed positions. The bottom plate 508 may be viewed as a part of the casting valve 500 and may also be a part of a casting die. The latter further includes a top plate, not shown for brevity.

Similarly to the valve piston 302 of FIG. 3 and FIGS. 4A and 4B, the valve piston 502 has opposed front 504 and back 506 ends. The front end 504 (i.e. the top end in FIGS. 5A and 5B) is configured to face the molten metal injected into the casting die. An opening in the back end 506 of the valve piston 502 extends towards the front end 504 from the back end 506. A hollow shaft 512 extends downwards for slidably engaging the base 510. The valve piston 502 may include a perimeter cutout 514 for communicating the exhausted air to an air exhaust outlet 528. One or more U-cap seals 526 may be provided for sealing the hollow shaft 512.

A coolant delivery tube 518 may extend from the base 510 into the opening in the valve piston 502 through the hollow shaft 512, without contacting an inner wall of the opening in the valve piston 502 at any position of the valve piston 502. The inlet 511 is in fluid communication with the coolant delivery tube 518, and the outlet 513 is in fluid communication with the opening in the hollow shaft 512. In some embodiments, the inlet/outlet assignment may be reversed. More generally, an inlet/outlet pair may be provided in the base, one in fluid communication with the hollow shaft 512, and the other in fluid communication with the coolant delivery tube 518.

The diameter of the opening in the valve piston 502 is preferably much smaller than the diameter of the valve piston 502 itself. In some embodiments, a cross-sectional area of the opening is no greater than 10% of a cross-sectional area of the valve piston 502. In the above definition, the cross-sectional area is defined as an area perpendicular to an axis of symmetry of the valve piston 502. Also, in some embodiments, a distance between the open and closed positions of the valve piston 502, shown in FIGS. 5A and 5B respectively, is 4+/−1 mm.

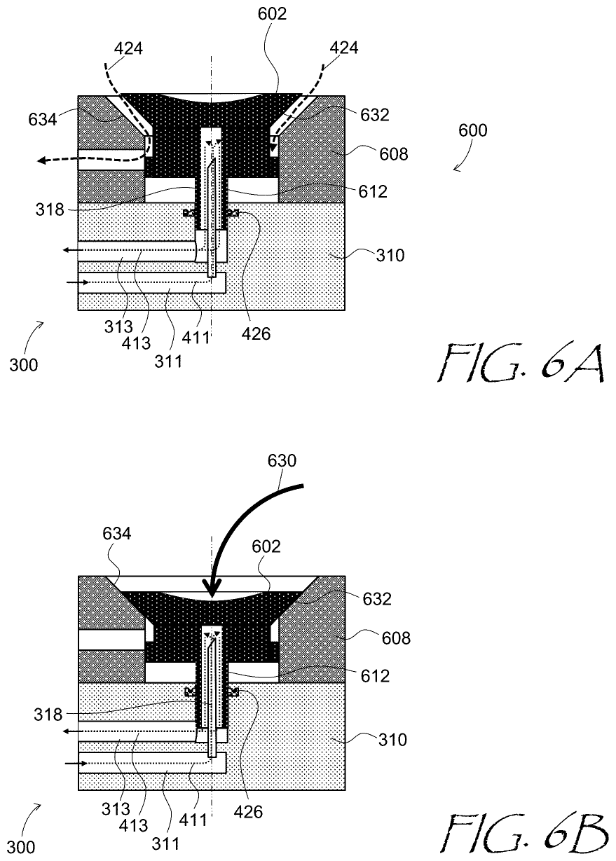

Referring to FIGS. 6A and 6B, a die casting valve 600 is an embodiment of the die casting valve 400 of FIGS. 4A and 4B and includes similar elements. Specifically, the die casting valve 600 includes the cooling apparatus 300 of FIG. 3 that may cool the valve 600 during the normal casting operation. The base 310 is mounted to a casting die portion 608. A valve piston 602 may slide or shift within the casting die portion 608 between open and closed positions. The valve piston 602 includes a conical surface 632 matching a conical surface 634 of the casting die portion 608.

In FIG. 6A, the valve 600 is shown in an open position that allows evacuation of the air 424 ahead of the stream of molten metal, which quickly fills the casting cavity during the casting process. In the embodiment shown, the air 424 may evacuate through a gap between the matching conical surfaces 632 and 634, as illustrated.

In FIG. 6B, the valve 600 is shown in a closed position that blocks the outflow of molten metal. Just like in FIG. 4B, the valve 600 may be closed shut by directing a stream 630 of the molten metal to impinge at a near normal angle onto its top concave surface. The molten metal may be directed to push the valve piston 602 by the mere kinetic momentum of the molten metal stream 630. The concave top surface of the valve piston 602 facilitates redirection of the stream of molten metal sideways and upwards, providing enough time for the valve 600 to close before the molten metal reaches the sides of the valve piston 602.

In the closed position illustrated in FIG. 6B, the conical surface 632 of the valve piston 602 rests on the matched conical surface 634 of the casting die portion 608. One advantage provided by the matching conical surfaces 632 and 634 is that, as the liquid metal pressure builds above the valve piston 602, the two conical surfaces are pressed together more strongly, preventing the molten metal outflow at the elevated pressure.

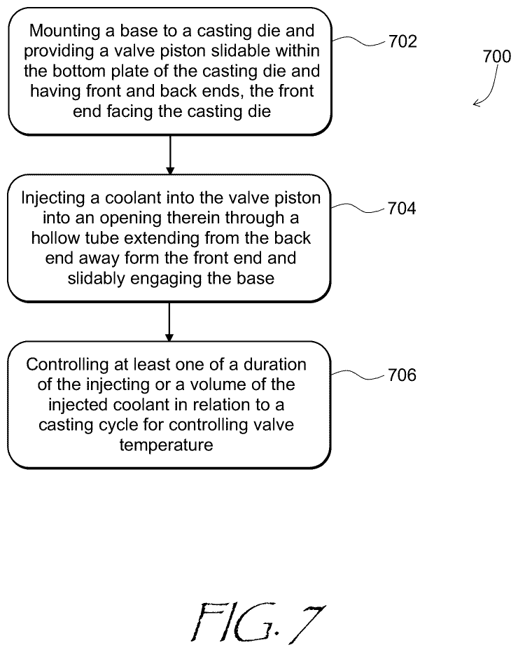

Turning now to FIG. 7 with further reference to FIG. 3 and FIGS. 4A and 4B, a method 700 (FIG. 7) for cooling a valve piston of this disclosure may include mounting (702) a base, e.g. the base 310 (FIGS. 4A and 4B) to a casting die, e.g. the casting die 420, and providing a valve piston, e.g. the valve piston 302, slidable within a bottom plate of the casting die 420 and having front and back ends, the front end facing the casting die 420. The valve piston and the bottom plate may form a valve assembly. The method 700 includes injecting (FIG. 7; 704) a coolant into an opening, e.g. the opening 307A in FIG. 3 in the back end 306 of the valve piston 302 through a hollow shaft, e.g. the hollow shaft 312, extending from the opening 307A away from the front end 304 and slidably engaging the base 310 mounted to the casting die 420 (FIGS. 4A and 4B). The injecting 704 may be performed using a coolant delivery tube, e.g. the coolant delivery tube 318 (FIG. 3 and FIGS. 4A and 4B) extending from the base 310 into the opening 307A in the valve piston 302 through the hollow shaft 312, such that the coolant delivery tube 318 is not in a mechanical contact with the valve piston 302 at any position of the piston 302 in the bottom plate 308, i.e. in open or closed position of the piston 302, and any positions therebetween.

The method 700 of FIG. 7 may further include controlling (706) a time duration of the injecting, a volume of the injected coolant, or both, in relation to a single casting cycle, for providing a pre-defined temperature range of the valve piston. The cooling may be continuous or pulsed; in the pulsed cooling configuration, the timing of supplying the coolant may be selected in sync with the casting cycle. By way of non-limiting illustrative examples, the coolant may be supplied in sync with injecting the molten metal into the casting die with a pre- or post-delay if required, etc. The temperature range of the cooled valve piston may be selected to prevent excessive thermal expansion of the latter, because such excessive piston heating may lead to sticking of the valve piston in the casting die. The valve piston cooling apparatus of this disclosure provides the coolant to the valve piston without having to rely on any mechanical appendages to the piston, and without any mechanical contact of any solid surface with the moving valve piston. More generally, the cooling apparatus of this disclosure may be used to direct a cooling fluid flow to any axially movable object that undergoes periodic heating, without having to rely on a mechanical contact with the axially movable object.

Persons skilled in the art will appreciate in view of the teachings and disclosures presented herein that the internal cooling apparatus according to this disclosure offers significant advantageous utilities and/or functionality in comparison to the prior art, including, but not limited to: (a) an ability to cool the piston substantially as needed, i.e. without requiring the die to be opened or any external spraying of coolant onto the piston; and/or (b) the coolant fluid can be directed through the piston, while allowing it to move freely and/or without requiring any direct plumbing fitting onto the piston. The U-cup seals may reduce, minimize, and/or prevent leakage to/from the hollow shaft that directs the coolant fluid to the piston. It is further noted that O-ring(s) or other types of sliding seals may be used in place of the U-cup seals.

The present disclosure helps solve, obviate, and/or mitigate one or more problems associated with the prior art relating to cooling mechanisms for movable pistons in high-pressure die cast valves. The apparatuses and methods of this disclosure may be used by or in association with cooling mechanisms for die casting machinery, as described above; however, the present disclosure is not to be limited in scope by the specific embodiments described herein, as these are disclosed for the purposes of illustration.

Other various embodiments and modifications, in addition to those described herein, may be apparent to those of ordinary skill in the art from the foregoing description and accompanying drawings. Thus, such other embodiments and modifications are intended to fall within the scope of the present disclosure. Although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth of the present disclosure as described herein.

What is claimed is:

1. A cooling apparatus for a valve piston comprising opposed front and back ends, the front end for facing a molten metal injected into a casting die, the cooling apparatus comprising:
a base mountable to the casting die;
an opening in the back end of the valve piston extending towards its front end; and
a hollow shaft extending from the opening for slidably engaging the base.

2. The cooling apparatus of claim 1, wherein the opening is substantially parallel to a movement direction of the valve piston or coaxial with the valve piston.

3. The cooling apparatus of claim 1, wherein the coolant delivery apparatus is absent any plumbing passages affixed to the valve piston.

4. The cooling apparatus of claim 1, further comprising a slidable seal for sealing the hollow shaft in the base.

5. The cooling apparatus of claim 1, wherein the valve piston is configured to slidably engage an opening in the casting die.

6. The cooling apparatus of claim 5, further comprising a coolant delivery tube extending from the base into the opening in the back end through the hollow shaft.

7. The cooling apparatus of claim 6, wherein the coolant delivery tube is not in mechanical contact with the valve piston at any position thereof, when in normal operation.

8. The cooling apparatus of claim 6, further comprising an inlet/outlet pair in the base, one in fluid communication with the hollow shaft, and the other in fluid communication with the coolant delivery tube.

9. A valve for a casting die, the valve comprising:
a base for mounting to the casting die;
a valve piston for sliding within the casting die between open and closed positions, the valve piston comprising:
opposed front and back ends, the front end for facing the molten metal injected into the casting die;
an opening in the back end extending towards the front end; and
a hollow shaft extending from the opening away from the front end for slidably engaging the base.

10. The valve of claim 9, wherein the opening is substantially parallel to a movement direction of the valve piston or substantially coaxial with the valve piston.

11. The valve of claim 9, further comprising a slidable seal for sealing the hollow shaft in the base.

12. The valve of claim 9, further comprising a coolant delivery tube extending from the base into the opening through the hollow shaft.

13. The valve of claim 12, wherein the coolant delivery tube is substantially parallel to the opening and the hollow shaft.

14. The valve of claim 12, wherein the coolant delivery tube is not in a mechanical contact with the valve piston at any position thereof in the casting die during normal operation.

15. The valve of claim 12, further comprising an inlet/outlet pair in the base, one in fluid communication with the hollow shaft, and the other in fluid communication with the coolant delivery tube.

16. The valve of claim 9, wherein at least one of: a cross-sectional area of the opening is no greater than 10% of a cross-sectional area of the valve piston; or a distance between the open and closed positions of the valve piston is 4+/−1 mm.

17. The valve of claim 9, wherein the valve piston comprises a conical surface resting on a matched conical surface of the casting die when the valve piston is in the closed position.

18. A method for cooling a valve piston comprising opposed front and back ends, the front end facing the molten metal injected into a casting die, the method comprising:
injecting a coolant into an opening in the back end of the valve piston through a hollow shaft extending from the opening away from the front end and slidably engaging a base mounted to the casting die.

19. The method of claim 18, further comprising controlling at least one of a duration of the injecting or a volume of the injected coolant in relation to a single casting cycle, for providing a pre-defined temperature range of the valve piston.

20. The method of claim 18, wherein the injecting is performed using a coolant delivery tube extending from the base into the opening in the valve piston through the hollow shaft, wherein the coolant delivery tube is not in a mechanical contact with the valve piston at any position thereof in the casting die.
